(19) United States
(12) Patent Application Publication
(10) Pub. No.: US 2008/0068612 A1
(43) Pub. Date: Mar. 20, 2008

(54) Fourier-transform spectrometers

(76) Inventor: Christopher J. Manning, Troy, ID (US)

Correspondence Address: Christopher Manning, 419 South Main Street, PO Box 265, Troy, ID, 83871, US

(21) Appl. No.: 11/805,897

(22) Filed: May 26, 2007

Related U.S. Application Data
(63) Continuation-in-part of application No. 09/922,363, filed on Aug. 2, 2001, now Pat. No. 7,224,464.
(60) Provisional application No. 60/288,273, filed on May 2, 2001.
(60) Provisional application No. 60/242,232, filed on Oct. 17, 2000.
(60) Provisional application No. 60/222,800, filed on Aug. 2, 2000.

(51) Int. Cl. G01J 3/45

(52) U.S. Cl. 356/452

(57) ABSTRACT

A novel tilt-insensitive interferometer geometry is described. The design uses tilt-insensitive optics to simultaneously maintain high throughput and precise interferometric alignment, even in the presence of non-ideal scanning motions. A variety of enhancements to the basic design are described, providing a family of related interferometer designs. These spectrometers have applications in spectrometry, spectral imaging and metrology.

### RELATED APPLICATIONS

This is a CONTINUATION of pending prior application Ser. No. 09/922,363 filed on Aug. 2, 2001. The Ser. No. 09/922,363 application claims the benefit of Provisional Applications Ser. Nos. 60/288,273 filed May 2, 2001, 60/242,232 filed Oct. 17, 2000, 60/222,800 filed Aug. 2, 2000, 60/199,429 filed Feb. 9, 1999, and 60/107,060 filed Nov. 4, 1998. The Ser. No. 09/922,363 application is related to U.S. Pat. No. 6,469,790, by this author.

Previous filings by the author are included by reference for the entirety of their disclosures. The first is Ser. No. 09/922,363, filed Aug. 2, 2001. Another is “Tilt-Compensated Interferometers,” filed Oct. 21, 2002, Ser. No. 10/277,439 which issued as U.S. Pat. No. 6,967,722 on Nov. 22, 2005. More are provisional applications Ser. No. 60/107,060, filed Nov. 4, 1998, titled “FT-IR Signal Processing: Part I,” Ser. No. 60/119,429, filed Feb. 9, 1999, titled “FT-IR Signal Processing: Part II,” a formal application entitled “Signal Processing for Interferometric Spectrometry” Ser. No. 09/433,964 filed Nov. 4, 1999. Further provisional applications which are included for the entirety of their disclosures are titled “Interferometers and Interferometry,” Ser. No. 60/228,800, filed Aug. 2, 2000, titled “Interferometers and Interferometry: Part 2,” Ser. No. 60/242,232, filed Oct. 17, 2000, and titled “Interferometers and Interferometry: Part 3,” Ser. No. 60/288,273 filed May 2, 2001. The book by Griffiths and deHaseth, “Fourier transform spectrometry,” ISBN 0-471-09902-3, also is included for the entirety of its content.

Portions of the inventions disclosed here have been made under contracts with the United States Federal Government through the Department of Defense under one or more of the following contracts DAAD-13-P-0012, DAAD13-02-C-0003, N0001403M0174, NAS1-03033, DAAD13-03-P-0076, W911-SR-04-C-0067, W911SR-05-C-0046, W911SR-05-P-0043, W911SR-06-C-0030. The Government has certain rights in these inventions.

### BACKGROUND AND SUMMARY OF THE INVENTION

It is an object of the present inventions to provide new interferometers, which are better than prior art in respect to stability, scan speed and cost of manufacture. It is an object of the present inventions to provide signal-processing techniques for interferometry, particularly very rapid scan interferometry. It is an object of the present inventions to improve the state-of-the-art in photometric accuracy of interferometric measurements.

Some of the major problems with prior art interferometric spectrometers include sensitivity to misalignment, requirement for extreme precision in scanning mechanism and high cost. Some aspects of the present inventions are intended to improve performance and reduce cost.

### BRIEF DESCRIPTION OF THE DRAWINGS

FIG. 1 shows a diagram of a prior art interferometric spectrometer.

FIG. 2 shows a diagram of an interferometric spectrometer.

FIG. 3 shows a diagram of a drive motor mechanism.

FIG. 4A shows a diagram of a compensator mounting plate.

FIG. 4B shows a diagram of a compensator mounting plate.

FIG. 5A shows a diagram of a mirror mounting and adjusting mechanism.

FIG. 5B shows a diagram of a mirror mounting and adjusting mechanism.

### DETAILED DESCRIPTION

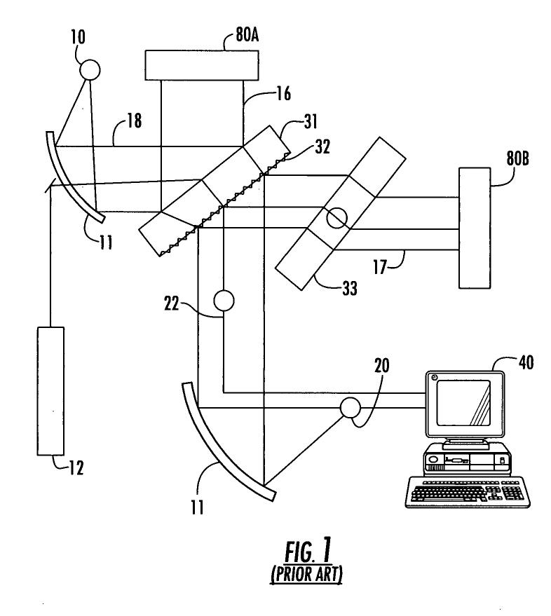

FIG. 1 is adapted from a patent issued to Barringer in the late-1960's. Some of his inventions disclose the use of a tilting refractive plate to vary optical path difference in an interferometer. The present inventions seek to improve on the prior art by providing drive and support mechanisms for the optical components of an interferometric spectrometer, as well as appropriate signal processing and control algorithms. The general concepts of operation are that optical radiation from a source passes into an interferometer that is related to Michelson's design. The radiation is divided into first and second beams of radiant energy that propagate in first and second optical paths. In FIG. 1, the first path is transmitted by the beamsplitter and propagates through a tilting compensator to a mirror 1. The beam reflected by the beamsplitter propagates to a mirror 2. Both beams reaching mirrors 1 and 2 are reflected back directly on themselves such that they recombine at the beamsplitter. A new beam is formed that propagates to the detector via a focusing mirror. The signal from the detector is processed according to methods described herein and in the literature to obtain spectral information. A laser signal is propagated through the system on a path parallel to the radiant energy beams already described. The utility of these devices has been described thoroughly by Barringer, Griffiths and many others.

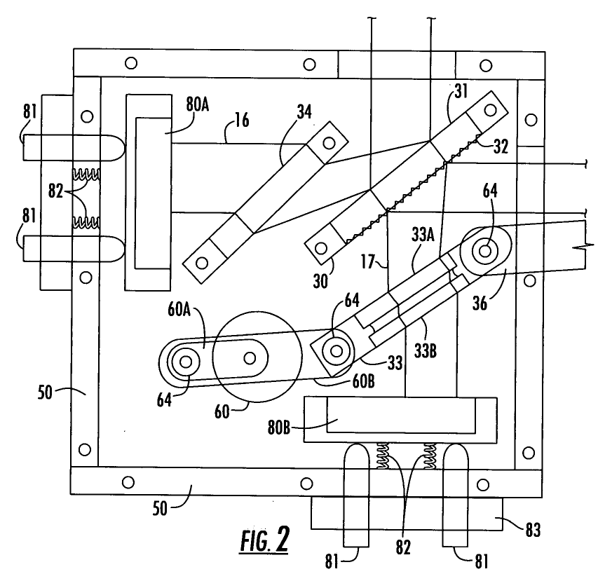

FIG. 2 shows a diagram of a robust implementation of an interferometer for use in the practice of interferometric spectrometry. The preferred material of construction is aluminum, which is relatively inexpensive, rigid, easy to machine and has a high thermal conductivity that tends to maintain the components isothermal. Preferably all of the components are mounted to the aluminum frame in such a manner as to preserve alignment over a wide range of temperature. FIG. 2 shows the outline of a box formed from aluminum plates, preferably of ¼-inch thickness; the plates may be light-weighted by removing material in such a way as to maintain rigidity, while minimizing weight. The plates may be held together by machine screws. Typically steel alloy or stainless steel alloy machine screws are used. To mitigate any deformation that can be caused by expansion coefficient mismatch between the machine screws and aluminum, the screws may be tensioned with Belleville spring washers. Within the aluminum box housing are mounted numerous components, including a beamsplitter and first compensator with drive motor. A second and third compensator, which are optional, may be located in the box, with suitable support for the second and third compensators. Two mirrors are supported by the box sides. The beamsplitter substrate preferably is made from a material transparent to the reference laser wavelength and the radiant energy of interest, which often is infrared radiation. In many cases, the preferred material is potassium bromide, which is relatively fragile and has a large coefficient mismatch to aluminum. Generally, the beamsplitter substrate and other optical components in the system, such as mirrors, may have a thermal coefficient of expansion that is different from aluminum. Care must be taken in mounting these components such that their alignment precision is preserved over temperature. The beamsplitter may be mounted in an aluminum plate, in which is machined a cylindrical bore slightly larger in diameter than the substrate. A second cylindrical bore that is slightly smaller than the beamsplitter diameter may be concentric to the first and go all the way through the plate. The first cylindrical bore should be slightly less deep than the thickness of the beamsplitter such that a ring of material is left at the bottom of the bore. The beamsplitter then can be pressed against the bottom of the bore by compliant washers and screws positioned at the periphery of the larger bore. Thus, the alignment of the beamsplitter is very precisely registered to the machined aluminum surface of the ring of material at the bottom of the bore. The first compensator may be mounted in an aluminum plate with such a bore geometry. The tilting compensator plate has the same geometry as the beamsplitter mounting plate, except that there may be two larger bores, one on each side, leaving only one ring of material between the two larger bores. Thus, two compensators may be mounted in opposition on a single plate. The tilting motion preferably is driven by a motor, which may be a DC gearmotor of the type manufactured by Maxon, Micromo or Portescap, a stepper motor of the type manufactured by Oriental Motor, or a brushless DC motor of the type manufactured by Maxon. If a stepper motor is used, it should be powered by a microstepping drive to minimize vibration. The tilting motion can be driven through a crank with excellent precision.

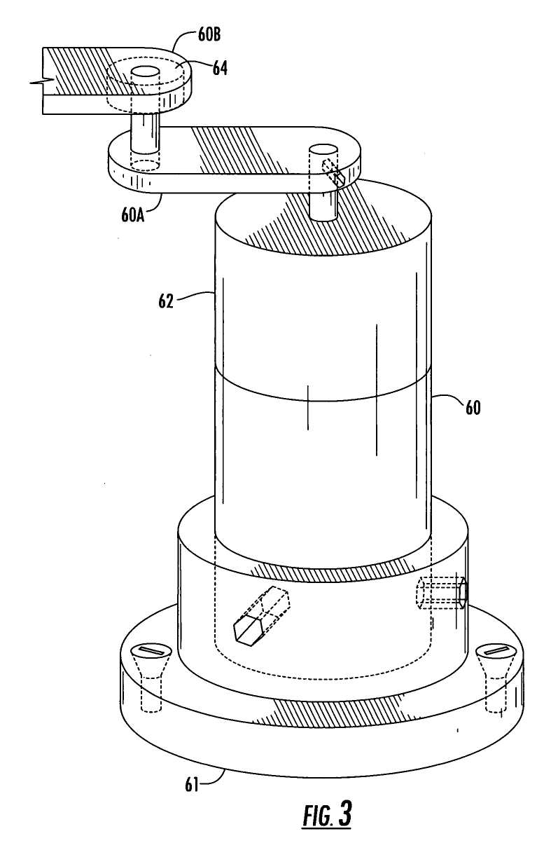

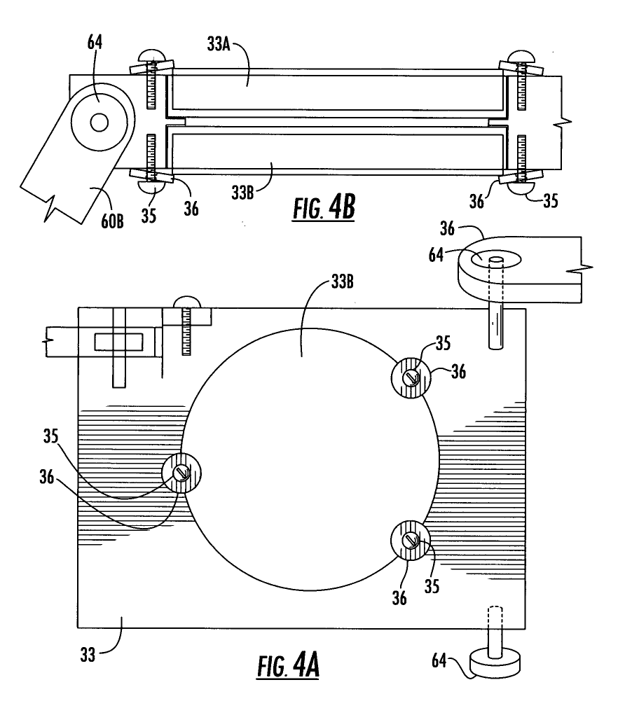

FIG. 3 shows detail of a motor, support and crank mechanism. The crank preferably is machined from a thin piece of aluminum of ⅛″ or 3/16″ thickness. The crank can be secured to the motor shaft with a brass-tipped set screw threaded into the crank; alternatively it may be fastened with an adhesive such as high-strength Loctite® or epoxy. The motor preferably is clamped rigidly at its base as shown in FIG. 3. The base may be machined from an aluminum plate or rod using a lathe and mill. A brass- or plastic-tipped set screw can secure the motor to the base. The base itself can be secured to the bottom plate of the housing with machine screws. The lengths of the crank arm and the connecting rod can be matched to the range of motion of the tilting compensator according. The preferred method for sizing the crank and connecting rods is to use Solidworks® computer-aided-design software to test range of motion until the desired angular sweep is obtained with sufficient clearance to avoid impacting the fixed mirror and beamsplitter mounts. The motor speed may be controlled by a computer program that monitors the modulation frequency from a laser detector equivalent to that shown in FIG. 1. Small bearings are placed at both ends of the connecting rod to provide for smooth motion; such bearings are available from a number of well known vendors. For certain applications, particularly photoacoustic measurements, where minimal variation of modulation frequency is preferred, the two bearings can be preloaded with a spring that connects the centers of the shafts, providing a force that acts through the bearings. The bearings at the top and bottom of the tilting compensator plate (FIG. 4) also can be preloaded to remove free play, also using springs connecting through the shaft centers.

FIG. 4A shows a front view of a tilting compensator holder, of the general type described relative to a beamsplitter mount in the detailed discussion of FIG. 2. FIG. 4B shows a section view of the same device. FIG. 4A shows that a compensator disk is secured to the plate with three screws. Typically these screws may have 2-56 threads. Typically, the compensators may have diameters equal to or near 2.25″. Compliant washers, which preferably are nylon, spread the force over a region at the edge of the disk. Typically, transparent materials are relatively brittle. Stress concentrations, such as those that are generated by point contact with metal, such as a screw hard or conventional metallic washer, preferably are avoided. FIG. 4A also shows that the right side of the tilting compensator mount is supported by two bearings, one located in the bottom of the housing and the other near the top. The upper left side of FIG. 4A shows that the connecting rod is coupled to the tilting compensator mounting plate by a bearing. FIG. 4B shows further details of the tilting compensator mounting plate, including the internal feature of a lip between compensator disk 2 and compensator disk 3.

For a given spectral resolution, a thicker compensator plate is preferred because the tilt-angle range can be smaller, resulting in a smaller variation of reflection loss along the optical path difference axis. The use of second and third compensator plates is preferable only from a cost perspective, because it increases the reflection losses in that arm of the interferometer, generally causing them to be mismatched to the reflection losses in the other arm. The term arm here is used interchangeably with terms first optical path and second optical path. The reflection losses vary with the scan angle of the compensator plate and may be compensated in the signal processing to provide very high photometric accuracy.

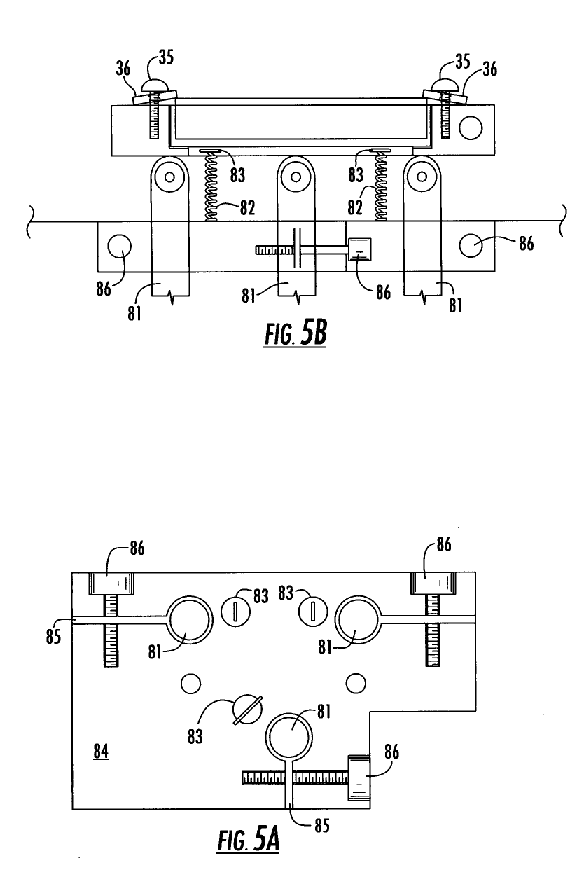

FIG. 5 shows details of the preferred mirror mounting geometry or fixturing. This geometry is extremely stable and compatible with automated, one-time, and/or factory-adjusted high volume production. Preferably all major components including the mirrors, pegs, clamp plate and housing are fabricated from aluminum, such they have matching thermal expansion coefficients. The springs preferably are steel, and each plate may have a carbide insert for a steel ball at the end of the support pegs to bear on. The steel balls may be mounted at the ends of the aluminum pegs to provide a hard surface. Because all three balls have the same coefficient of expansion, their presence does not degrade the alignment stability, in spite of the coefficient mismatch to aluminum. The mirror is clamped in a manner analogous to the beamsplitter and compensator mounts described above. The springs pull the mirror mounting plate firmly against the pegs. The pegs can be clamped and unclamped independently by loosening the clamping screws on the clamp plate. The position of the pegs can be adjusted with high precision differential screws while monitoring the interferometric alignment of the interferometer with an expanded laser beam, using principles well known in the art of interferometry. When the pegs are positioned correctly, the clamp screws are tightened carefully. The tips of the pegs engage features on the back of the aluminum mirror mounting plates. Such features are well known in commercial mirror positioning hardware. The three points of contact have three different constraints to produce a properly constrained geometry for the mirrors. The first contact is a flat plate that is constrained only in one translation axis, along the length of the screw. The second contact is a grooved plate that is constrained along the axis of the screw and in one orthogonal axis along the groove. The third contact is constrained in all three translation axes by a conical or spherical bore. By matching the coefficient of expansion of the pegs to the coefficient of expansion of the overall apparatus, the,sensitivity to alignment change with temperature is greatly reduced. Further, the cost is reduced, because the simple aluminum pegs are much less expensive than the differential screws that they permanently replace.

The principles, embodiments and modes of operation of the present inventions have been set forth in the foregoing provisional specification. The embodiments disclosed herein should be interpreted as illustrating the present invention and not as restricting it. The foregoing disclosure is not intended to limit the range available to a person of ordinary skill in the art in any way, but rather to expand the range in ways not previously considered. Numerous variations and changes can be made to the foregoing illustrative embodiments without departing from the scope and spirit of the present inventions.

What is claimed is:

1. A spectrometer, comprising:
a source of a primary beam of radiant energy;
a beamsplitter fixed in relation to the primary beam, for dividing primary beam into at least first and second energy beams which follow first and second optical paths;
two mirrors mounted on thermally stable alignment fixturing;
a reference source coupled to the spectrometer;
a first refractive element mounted on one or more bearings, for varying the optical path length in a first optical path;
at least one return reflector for reflecting the first beam back to the beamsplitter;
at least one radiant energy detector;
a control, data acquisition and processing electronic system;
